(19) United States
(12) Patent Application Publication
(10) Pub. No.: US 2024/0144499 A1
(43) Pub. Date: May 2, 2024

(54) INFORMATION PROCESSING DEVICE, INFORMATION PROCESSING METHOD, AND INFORMATION PROCESSING PROGRAM

(71) Applicant: Socionext Inc., Kanagawa (JP)

(72) Inventor: Kazuyuki OHHASHI, Yokohama (JP)

(21) Appl. No.: 18/543,856

(22) Filed: Dec. 18, 2023

Related U.S. Application Data
(63) Continuation of application No. PCT/JP2021/023999, filed on Jun. 24, 2021.

(51) Int. Cl. G06T 7/33; G06T 3/00; G06T 7/20; G06T 7/579; G06T 7/73

(52) U.S. Cl. CPC G06T 7/33; G06T 3/00; G06T 7/20; G06T 7/579; G06T 7/74; G06T 2207/10028; G06T 2207/20212; G06T 2207/30244; G06T 2207/30252

(57) ABSTRACT

An information processing device includes a VSLAM processing unit as an acquisition unit, a difference calculation unit and an offset processing unit as alignment processing units, and an integration unit as an integration processing unit. The VSLAM processing unit acquires first point cloud information based on first image data obtained from a first image capturing unit provided at a first position of a moving body, and acquires second point cloud information based on second image data obtained from a second image capturing unit provided at a second position different from the first position of the moving body. The difference calculation unit and offset processing unit perform alignment processing on the first and second point cloud information. The integration unit generates integrated point cloud information by using the first point cloud information and the second point cloud information on both of which the alignment processing has been performed.

### CROSS-REFERENCE TO RELATED APPLICATIONS

This application is a continuation of International Application No. PCT/JP2021/023999, filed on Jun. 24, 2021, the entire contents of which are incorporated herein by reference.

### FIELD

Embodiments described herein relate generally to an information processing device, an information processing method, and an information processing program.

### BACKGROUND

There is a technique referred to as simultaneous localization and mapping (SLAM) that acquires information regarding a surrounding three-dimensional object of a moving body such as a vehicle, as point cloud information, and estimates information regarding self-position and the position of the surrounding three-dimensional object. In addition, there is a technology referred to as visual simultaneous localization and mapping (Visual SLAM or VSLAM) that performs SLAM using an image captured by a camera.

Conventional techniques are described in JP 2018-205949 A, JP 2016-045874 A, JP 2016-123021 A, WO 2019/073795 A, WO 2020/246261 A and “Vision SLAM Using Omni-Directional Visual Scan Matching” 2008 IEEE/RSJ International Conference on Intelligent Robots and Systems, 22-26 Sep. 2008.

In the VSLAM processing, however, there is an issue of shortage of position information of the surrounding objects obtained in the VSLAM processing, for example. This might lead to unstable detection of the position of the surrounding object and the self-position by the VSLAM.

### SUMMARY

### Brief Description of the Drawings

FIG. 1 is a diagram illustrating an example of an overall configuration of an information processing system according to an embodiment;

FIG. 2 is a diagram illustrating an example of a hardware configuration of the information processing device according to the embodiment;

FIG. 3 is a diagram illustrating an example of a functional configuration of the information processing device according to the embodiment;

FIG. 4 is a schematic diagram illustrating an example of environmental map information according to the embodiment;

FIG. 5 is a plan view illustrating an example of a situation in which a moving body is parked with reverse parking in a parking lot;

FIG. 6 is a plan view illustrating an example of an image capturing range of an image capturing unit provided in front of a moving body in a case where the moving body moves forward;

FIG. 7 is a plan view illustrating an example of an image capturing range of an image capturing unit provided in rear of a moving body in a case where the moving body moves backward;

FIG. 8 is a diagram illustrating an example of point cloud information related to the front of a moving body generated by VSLAM processing in a case where the moving body temporarily moves forward along a track;

FIG. 9 is a diagram illustrating an example of point cloud information related to the rear of a moving body generated by the VSLAM processing in a case where the moving body temporarily moves backward along a track;

FIG. 10 is a diagram illustrating an example of integrated point cloud information generated by integration processing in the reverse parking of the moving body illustrated in FIG. 5;

FIG. 11 is a flowchart illustrating an example of a flow of the integration processing illustrated in FIGS. 5 to 10;

FIG. 12 is a diagram illustrating an asymptotic curve generated by a determination unit;

FIG. 13 is a schematic view illustrating an example of a reference projection plane;

FIG. 14 is a schematic diagram illustrating an example of a projection shape determined by the determination unit;

FIG. 15 is a schematic diagram illustrating an example of a functional configuration of an integration processing unit and a determination unit;

FIG. 16 is a flowchart illustrating an example of a flow of information processing performed by the information processing device;

FIG. 17 is a flowchart illustrating an example of a flow of point cloud integration processing in step S27 of FIG. 16; and

FIG. 18 is a diagram illustrating point cloud information related to rear VSLAM processing of an information processing device according to a comparative example.

### DETAILED DESCRIPTION

Hereinafter, embodiments of an information processing device, an information processing method, and an information processing program disclosed in the present application will be described in detail with reference to the accompanying drawings. Note that the following embodiments are not to limit the disclosed technology. Each embodiment can be appropriately combined with each other within a range not causing contradiction of processing.

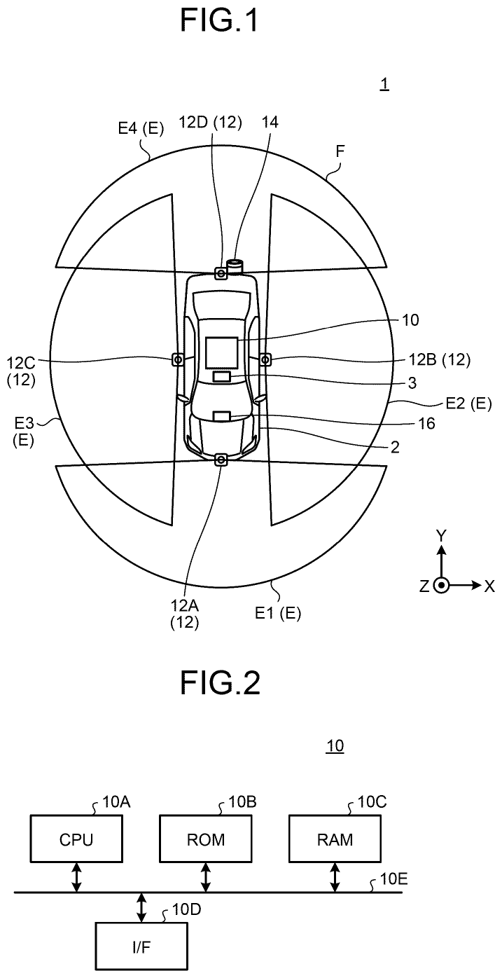

FIG. 1 is a diagram illustrating an example of an overall configuration of an information processing system 1 of the present embodiment. The information processing system 1 includes an information processing device 10, an image capturing unit 12, a detection unit 14, and a display unit 16. The information processing device 10, the image capturing unit 12, the detection unit 14, and the display unit 16 are connected to each other so as to be able to exchange data or signals.

The present embodiment will describe an exemplary mode in which the information processing device 10, the image capturing unit 12, the detection unit 14, and the display unit 16 are mounted on the moving body 2.

The moving body 2 is a movable object. Examples of the moving body 2 include a vehicle, a flying object (manned airplane, unmanned airplane (for example, an unmanned aerial vehicle (UAV) or a drone)), and a robot. The moving body 2 is, for example, a moving body that travels through a driving operation by a person, or a moving body that can automatically travel (autonomously travel) without a driving operation by a person. The present embodiment will describe an exemplary case where the moving body 2 is a vehicle. Examples of the vehicle include a two-wheeled automobile, a three-wheeled automobile, and a four-wheeled automobile. The present embodiment will describe an exemplary case where the vehicle is an autonomously traveling four-wheeled automobile.

There is no need to limit the configuration to the mode in which all of the information processing device 10, the image capturing unit 12, the detection unit 14, and the display unit 16 are mounted on the moving body 2. The information processing device 10 may be mounted on a stationary object. The stationary object is an object fixed to the ground. The stationary object is an immovable object or an object staying in a stationary state on the ground. Examples of the stationary object include a traffic light, a parked vehicle, and a road sign. Furthermore, the information processing device 10 may be mounted on a cloud server that performs processing on a cloud.

The image capturing unit 12 captures an image of the surroundings of the moving body 2 and acquires captured image data. Hereinafter, the captured image data will be simply referred to as a captured image. An example of the image capturing unit 12 is a digital camera capable of capturing a moving image. Note that image capturing refers to conversion of an image of a subject formed by an optical system such as a lens into an electric signal. The image capturing unit 12 outputs the captured image to the information processing device 10. Furthermore, in the present embodiment, a description will be given on the assumption that the image capturing unit 12 is a monocular fisheye camera (for example, the viewing angle is 195 degrees).

In the present embodiment, a mode in which four image capturing units 12 (image capturing units 12A to 12D) are mounted on the moving body 2 will be described as an example. The plurality of image capturing units 12 (image capturing units 12A to 12D) captures a subject in individual image capturing regions E (image capturing regions E1 to E4) to acquire a captured image. Note that it is assumed that the plurality of image capturing units 12 have different image capturing directions. In addition, it is assumed that the image capturing directions of the plurality of image capturing units 12 are adjusted in advance such that at least a part of the image capturing regions E overlaps with each other between the adjacent image capturing units 12.

The four image capturing units 12A to 12D are examples, and the number of the image capturing units 12 is not limited. For example, in a case where the moving body 2 has a long rectangular shape like a bus or a truck, it is also possible to dispose a total of six image capturing units 12 by disposing each one image capturing units 12 in each position of the front, the rear, the front right side surface, the rear right side surface, the front left side surface, and the rear left side surface of the moving body 2. That is, the number and arrangement positions of the image capturing units 12 can be flexibly set according to the size and shape of the moving body 2. Note that the present invention can be implemented by providing at least two image capturing units 12.

The detection unit 14 detects position information of each of a plurality of detection points in the surroundings of the moving body 2. In other words, the detection unit 14 detects the position information of each of the detection points in a detection region F. The detection point indicates each of points individually observed by the detection unit 14 in the real space. The detection point corresponds to a three-dimensional object in the surroundings of the moving body 2, for example.

The position information of the detection point is information indicating the position of the detection point in the real space (three-dimensional space). For example, the position information of the detection point is information indicating a distance from the detection unit 14 (that is, the position of the moving body 2) to the detection point and indicating a direction of the detection point based on the detection unit 14. The distance and direction can be expressed by position coordinates indicating a relative position of the detection point with reference to the detection unit 14, position coordinates indicating an absolute position of the detection point, or a vector, for example.

Examples of the detection unit 14 include a three-dimensional (3D) scanner, a two dimensional (2D) scanner, a distance sensor (millimeter wave radar and laser sensor), a sonar sensor that detects an object by sound waves, and an ultrasonic sensor. The laser sensor is, for example, a three-dimensional Laser imaging Detection and Ranging (LiDAR) sensor. The detection unit 14 may be a device using a technology of measuring a distance from an image captured by a stereo camera or a monocular camera, such as a Structure from Motion (SfM) technology, for example. Furthermore, a plurality of image capturing units 12 may be used as the detection unit 14. Furthermore, one of the plurality of image capturing units 12 may be used as the detection unit 14.

The display unit 16 displays various types of information. Examples of the display unit 16 include a liquid crystal display (LCD) and an organic electro-luminescence (EL) display.

In the present embodiment, the information processing device 10 is communicably connected to an electronic control unit (ECU) 3 mounted on the moving body 2. The ECU 3 is a unit that performs electronic control of the moving body 2. In the present embodiment, it is assumed that the information processing device 10 can receive Controller Area Network (CAN) data such as a speed and a moving direction of the moving body 2 from the ECU 3.

Next, a hardware configuration of the information processing device 10 will be described.

FIG. 2 is a diagram illustrating an example of a hardware configuration of the information processing device 10.

The information processing device 10 includes a central processing unit (CPU) 10A, read only memory (ROM) 10B, random access memory (RAM) 10C, and an interface (I/F) 10D, and an example of the information processing device 10 is a computer. The CPU 10A, the ROM 10B, the RAM 10C, and the I/F 10D are mutually connected by a bus 10E, and have a hardware configuration using a normal computer.

The CPU 10A is an arithmetic device that controls the information processing device 10. The CPU 10A corresponds to an example of a hardware processor. The ROM 10B stores programs and the like that implement various types of processing performed by the CPU 10A. The RAM 10C stores data necessary for various types of processing performed by the CPU 10A. The I/F 10D is an interface for connecting to units such as the image capturing unit 12, the detection unit 14, the display unit 16, and the ECU 3 to transmit and receive data with those units.

A program for performing information processing performed by the information processing device 10 of the present embodiment is provided as a program product pre-installed in a device such as the ROM 10B. Note that the program performed by the information processing device 10 according to the present embodiment may be provided by being recorded in a recording medium as a file in a format that can be installed or performed in the information processing device 10. The recording medium is a computer-readable medium. Examples of the recording medium include a compact disc (CD)-ROM, a flexible disk (FD), a CD-R (Recordable), a digital versatile disk (DVD), a universal serial bus (USB) memory device, and a secure digital (SD) card.

Next, a functional configuration of the information processing device 10 according to the present embodiment will be described. The information processing device 10 simultaneously estimates the position information of the detection point and the self-position information of the moving body 2 from the captured image captured by the image capturing unit 12 by visual SLAM processing. The information processing device 10 stitches a plurality of spatially adjacent captured images to generate and display a combined image overlooking the surroundings of the moving body 2. In the present embodiment, the image capturing unit 12 is used as the detection unit 14.

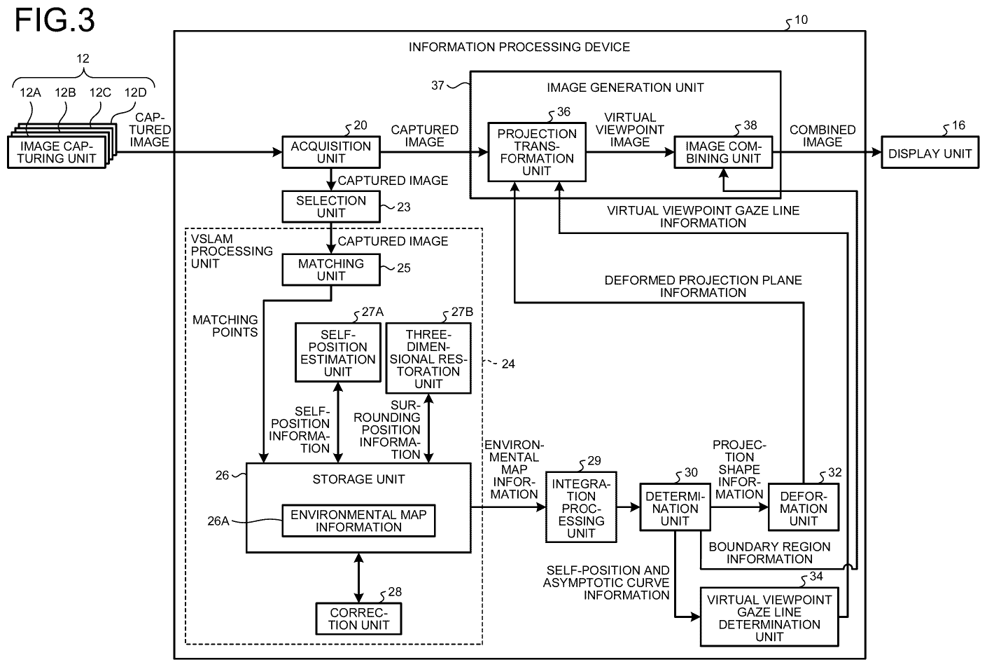

FIG. 3 is a diagram illustrating an example of a functional configuration of the information processing device 10. In order to clarify the data input/output relationship, FIG. 3 also illustrates the image capturing unit 12 and the display unit 16 in addition to the information processing device 10.

The information processing device 10 includes an acquisition unit 20, a selection unit 23, a VSLAM processing unit 24, an integration processing unit 29, a determination unit 30, a deformation unit 32, a virtual viewpoint gaze line determination unit 34, a projection transformation unit 36, and an image combining unit 38.

Some or all of the plurality of units may be implemented by causing a processing device such as the CPU 10A to run a program, that is, by software. In addition, some or all of the plurality of units may be implemented by hardware such as an integrated circuit (IC), or may be implemented by combining software and hardware.

The acquisition unit 20 acquires a captured image from the image capturing unit 12. The acquisition unit 20 acquires captured images individually from the image capturing units 12 (image capturing units 12A to 12D).

Every time a captured image is acquired, the acquisition unit 20 outputs the acquired captured image to the projection transformation unit 36 and the selection unit 23.

The selection unit 23 selects a detection region of a detection point. In the present embodiment, the selection unit 23 selects the detection region by selecting at least one image capturing unit 12 among the plurality of image capturing units 12 (image capturing units 12A to 12D).

In the present embodiment, the selection unit 23 selects at least one of the image capturing units 12 by using vehicle state information included in the CAN data received from the ECU 3, detection direction information, or instruction information input by the operation instruction by the user.

Examples of the vehicle state information include information indicating a traveling direction of the moving body 2, a state of a direction instruction of the moving body 2, and a state of a gear of the moving body 2. The vehicle state information can be derived from the CAN data. The detection direction information is information indicating a direction in which information of interest has been detected, and can be derived by a Point of Interest (POI) technology. The instruction information is assumed to be, for example, a case of selecting a type of parking to be performed, such as perpendicular parking or parallel parking in the automatic parking mode, and is information input by an operation instruction of the user.

For example, the selection unit 23 selects detection regions E (E1 to D4) using the vehicle state information. Specifically, the selection unit 23 specifies the traveling direction of the moving body 2 using the vehicle state information. The selection unit 23 stores in advance the traveling direction and identification information of any one of the image capturing units 12 in association with each other. For example, the selection unit 23 stores in advance identification information of the image capturing unit 12D (refer to FIG. 1) that captures an image of the rear of the moving body 2 in association with backward movement information. In addition, the selection unit 23 stores in advance identification information of the image capturing unit 12A (refer to FIG. 1) that images the front of the moving body 2 in association with forward movement information.

Subsequently, the selection unit 23 selects the detection region E by selecting the image capturing unit 12 corresponding to the parking information derived from the received vehicle state information.

The selection unit 23 may select the image capturing unit 12 having the direction indicated by the detection direction information as the image capturing region E. Furthermore, the selection unit 23 may select the image capturing unit 12 having the direction indicated by the detection direction information derived by the POI technology as the image capturing region E.

The selection unit 23 outputs the captured image captured by the selected image capturing unit 12, among the captured images acquired by the acquisition unit 20, to the VSLAM processing unit 24.

The VSLAM processing unit 24 acquires first point cloud information based on first image data obtained from the first image capturing unit, which is one of the image capturing units 12A to 12D. The VSLAM processing unit 24 acquires second point cloud information based on second image data obtained from the second image capturing unit, which is one of the image capturing units 12A to 12D and different from the first image capturing unit. That is, the VSLAM processing unit 24 receives the captured image captured by one of the image capturing units 12A to 12D from the selection unit 23, performs the VSLAM processing using the captured image to generate the environmental map information, and outputs the generated environmental map information to the determination unit 30. The VSLAM processing unit 24 is an example of an acquisition unit.

More specifically, the VSLAM processing unit 24 includes a matching unit 25, a storage unit 26, a self-position estimation unit 27A, a three-dimensional restoration unit 27B, and a correction unit 28.

The matching unit 25 performs feature extraction processing and image matching processing on a plurality of captured images each captured at different image capturing timings (a plurality of captured images of different frames). Specifically, the matching unit 25 performs feature extraction processing on the plurality of captured images. On a plurality of captured images having different capture timings, the matching unit 25 performs matching processing of specifying corresponding points between the plurality of captured images by using features between the plurality of captured images. The matching unit 25 outputs the matching processing result to the storage unit 26.

The self-position estimation unit 27A estimates a self-position relative to the captured image by projective transformation or the like using the plurality of matching points acquired by the matching unit 25. Here, the self-position includes information of the position (three-dimensional coordinates) and inclination (rotation) of the image capturing unit 12. The self-position estimation unit 27 stores the self-position information as point cloud information in environmental map information 26A.

The three-dimensional restoration unit 27B performs perspective projection transformation processing using the movement amount (the translation amount and the rotation amount) of the self-position estimated by the self-position estimation unit 27A, and determines the three-dimensional coordinates (relative coordinates with respect to the self-position) of the matching point. The three-dimensional restoration unit 27B stores the surrounding position information, which is the determined three-dimensional coordinates, as point cloud information in the environmental map information 26A.

With this configuration, new surrounding position information and new self-position information are sequentially added to the environmental map information 26A together with the movement of the moving body 2 on which the image capturing unit 12 is installed.

The storage unit 26 stores various types of data. Examples of the storage unit 26 include a semiconductor memory element such as RAM or flash memory, a hard disk, and an optical disk. The storage unit 26 may be a storage device provided outside the information processing device 10. The storage unit 26 may be a storage medium. Specifically, the storage medium may store or temporarily store a program or various types of information downloaded via a local area network (LAN), the Internet, or the like.

The environmental map information 26A is information obtained by registering point cloud information, which is the surrounding position information calculated by the three-dimensional restoration unit 27B, and registering point cloud information, which is the self-position information calculated by the self-position estimation unit 27A, in a three-dimensional coordinate space based on a predetermined position in the real space as an origin (reference position). The predetermined position in the real space may be determined based on a preset condition, for example.

For example, the predetermined position is a position of the moving body 2 when the information processing device 10 performs information processing of the present embodiment. For example, it is assumed that information processing is performed at a predetermined timing, such as in a parking scene of the moving body 2. In this case, the information processing device 10 may set, as the predetermined position, the position of the moving body 2 when it is discerned that the predetermined timing has been reached. For example, the information processing device 10 may judge that the predetermined timing has been reached when it has discerned that the behavior of the moving body 2 has shifted to a behavior indicating a parking scene. Examples of the behavior indicating a parking scene using backward movement include: a case where the speed of the moving body 2 is a predetermined speed or less; a case where the gear of the moving body 2 is set in the reverse; and a case of reception of a signal indicating the start of parking by a user's operation instruction, or the like. The predetermined timing is not limited to the parking scene.

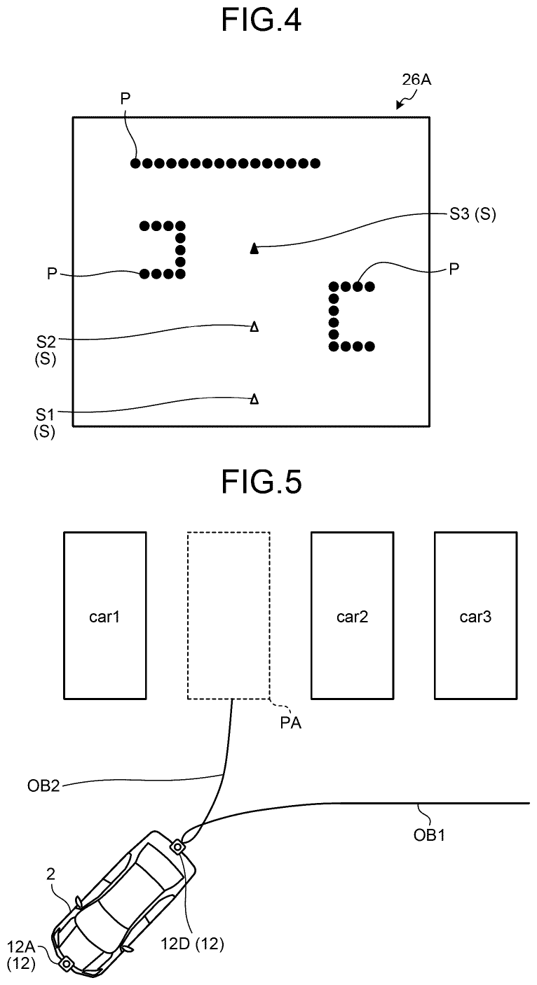

FIG. 4 is a schematic diagram of an example of the environmental map information 26A. As illustrated in FIG. 4, the environmental map information 26A is information in which point cloud information, which is position information (surrounding position information) of each of the detection points P, and point cloud information, which is self-position information of the self-position S of the moving body 2, are registered at corresponding coordinate positions in the three-dimensional coordinate space. In FIG. 4, the self-position S are illustrated as self-positions S1 to S3, as an example. This indicates that the larger the value of the numerical value following S, the closer the self-position S is to the current timing.

The correction unit 28 corrects the surrounding position information and the self-position information registered in the environmental map information 26A using a technique such as the least squares method, for example, so as to minimize the sum of the differences in distance in the three-dimensional space between the three-dimensional coordinates calculated in the past and the newly calculated three-dimensional coordinates regarding a point that has successfully matched a plurality of times between a plurality of frames. The correction unit 28 may correct the movement amount (translation amount and rotation amount) of the self-position used in the process of calculating the self-position information and the surrounding position information.

The timing of the correction processing by the correction unit 28 is not limited. For example, the correction unit 28 may perform the correction processing at predetermined timings. The predetermined timing may be determined based on a preset condition, for example. In the present embodiment, a case where the information processing device 10 includes the correction unit 28 will be described as an example. However, the information processing device 10 may omit the correction unit 28.

The integration processing unit 29 performs alignment processing on the first point cloud information and the second point cloud information received from the VSLAM processing unit 24. The integration processing unit 29 performs the integration processing by using the first point cloud information and the second point cloud information on which the alignment processing has been performed. Here, the integration processing is processing of aligning and integrating first point cloud information, which is point cloud information of the surrounding position information and the self-position information acquired using the image captured using the first image capturing unit, and second point cloud information, which is point cloud information of the surrounding position information and the self-position information acquired using the image captured using the second image capturing unit different from the first image capturing unit, so as to generate integrated point cloud information including at least both of the first point cloud information and the second point cloud information.

The integration processing performed by the integration processing unit 29 will be described below with reference to FIGS. 5 to 11.

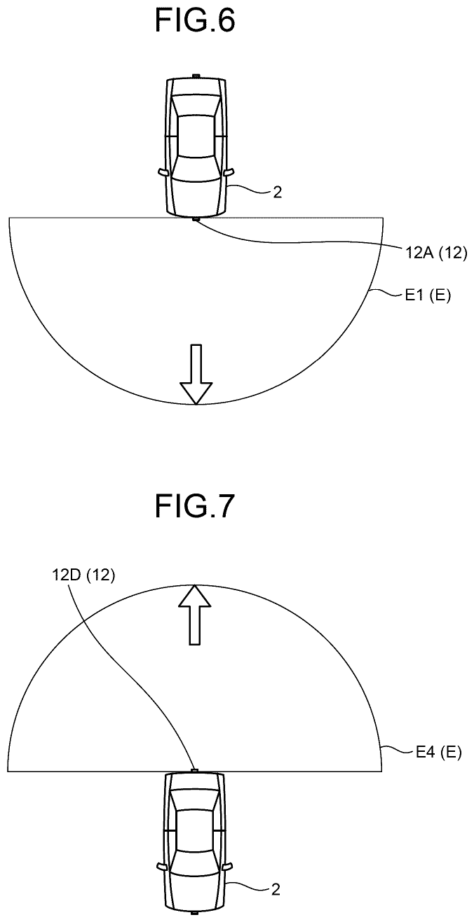

FIG. 5 is a plan view illustrating an example of a situation in which the moving body 2 is parked with reverse parking in a parking lot PA. FIG. 6 is a plan view illustrating an example of an image capturing range E1 of the image capturing unit 12A provided in front of the moving body 2 (hereinafter, the unit is also referred to as a “front image capturing unit 12A”) in a case where the moving body 2 moves forward. FIG. 7 is a plan view illustrating an example of the image capturing range E4 of the image capturing unit 12D provided behind the moving body 2 (hereinafter, the unit is also referred to as a “rear image capturing unit 12D”) in a case where the moving body 2 moves backward. Note that FIG. 5 illustrates a case where the moving body 2 is temporarily moved forward along a track OB1, then the gear of the moving body 2 is switched from the drive “D” to the reverse “R”, and to allow the moving body 2 to move backward along a track OB2 to be parked with reverse parking in the parking lot PA. Note that car1, car2, and car3 individually indicate other moving bodies parked in parking lots different from the parking lot PA.

Hereinafter, for specific description, an example of performing integration processing in a case where the moving body 2 performs reverse parking illustrated in FIG. 5 will be described.

When the moving body 2 temporarily moves forward along the track OB1, as illustrated in FIG. 6, the front image capturing unit 12A sequentially acquires images in the image capturing range E1 along with the movement of the moving body 2. The VSLAM processing unit 24 performs VSLAM processing using the image of the image capturing range E1 sequentially output from the selection unit 23, and generates point cloud information related to the front of the moving body 2. Note that the VSLAM processing using the image of the image capturing range E1 by the front image capturing unit 12A is hereinafter also referred to as “front VSLAM processing”. The front VSLAM processing is an example of first processing or second processing. In addition, the VSLAM processing unit 24 performs front VSLAM processing using a newly input image of the image capturing range E1, and updates the point cloud information related to the surroundings of the moving body 2.

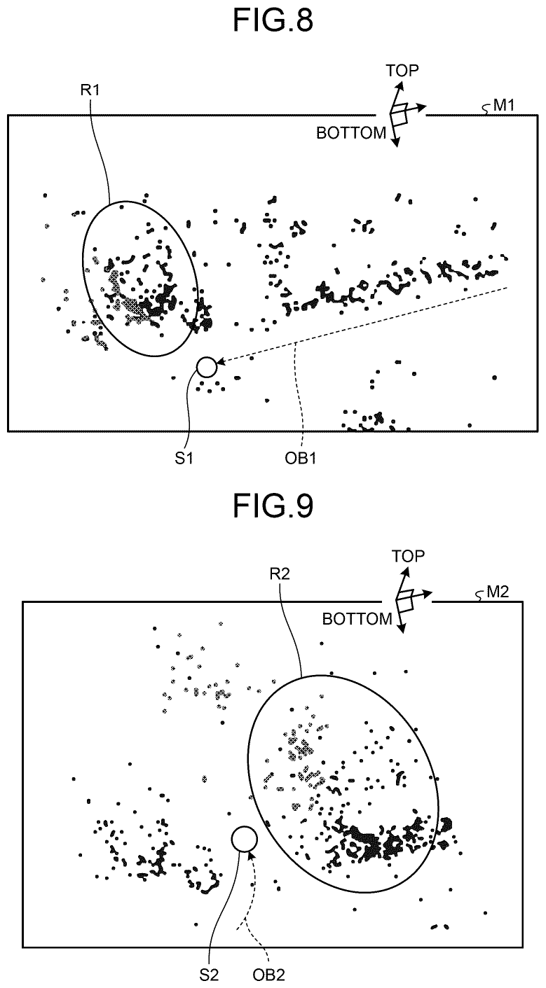

FIG. 8 is a diagram illustrating an example of point cloud information M1 related to the surroundings of the moving body 2 generated by the VSLAM processing unit 24 when the moving body 2 temporarily moves forward along the track OB1. In FIG. 8, a point cloud existing in a region R1 of the point cloud information M1 related to the front VSLAM processing is a point cloud corresponding to car1 in FIG. 5. Since the moving body 2 moves forward along the track OB1, the point cloud information corresponding to car1 can be acquired during a period in which car1 in FIG. 5 is within the image capturing range E1 and has been moved in the image. Therefore, as illustrated in FIG. 8, a large number of point clouds clearly exist in the region R1 corresponding to car1.

In addition, as illustrated in FIG. 7, after the moving body 2 moves forward along the track OB1, an image in the image capturing range E4 is sequentially acquired by the rear image capturing unit 12D along with the backward movement of the moving body 2 after the gear switching. The VSLAM processing unit 24 performs VSLAM processing using the image in the image capturing range E4 sequentially output from the selection unit 23, and generates the point cloud information related to the rear of the moving body 2. Hereinafter, the VSLAM processing using the image in the image capturing range E4 by the rear image capturing unit 12D is also referred to as “rear VSLAM processing”. The rear VSLAM processing is an example of the first processing or the second processing. In addition, the VSLAM processing unit 24 performs the rear VSLAM processing using the newly input image of the image capturing range E4, and updates the point cloud information related to the rear of the moving body 2.

FIG. 9 is a diagram illustrating an example of point cloud information M2 related to the rear of the moving body 2 generated by the VSLAM processing unit 24 in a case where the moving body 2 moves backward along the track OB2 after gear switching. In FIG. 9, a point cloud existing in the region R2 of the point cloud information M2 related to the rear VSLAM processing is a point cloud corresponding to car2 in FIG. 5. Since the moving body 2 moves backward along the track OB2, the point cloud information corresponding to car2 can be acquired during the period in which car2 in FIG. 5 is within the image capturing range E4 and appearing in the image. Therefore, as illustrated in FIG. 9, a large number of point clouds clearly exist in the region R2.

The integration processing unit 29 performs a point cloud alignment processing of the point cloud information M1 related to the front VSLAM processing and the point cloud information M2 related to the rear VSLAM processing, for example. Here, the point cloud alignment processing is processing of aligning a plurality of point clouds by performing arithmetic processing including at least one of translational movement (translation) or rotational movement for at least one of a plurality of point clouds to be defined as alignment targets. For example, in a case where the point cloud alignment processing of two pieces of point cloud information is performed, first, the self-position coordinates of both are aligned, surrounding point clouds in a certain range from the self-position are set as the alignment targets, a difference in positions between the corresponding points is obtained as a distance, and then, based on one reference position when a sum of the distances is a predetermined threshold or less, a translational movement amount of the other reference position with respect to the one reference position is obtained.

Note that the point cloud alignment processing may be any processing as long as the processing performs alignment between the target point cloud information. Examples of the point cloud alignment processing include scan matching processing using an algorithm such as an iterative closest point (ICP) or a normal distribution transform (NDT).

The integration processing unit 29 generates integrated point cloud information, which is an integration of the point cloud information M1 and the point cloud information M2, by using the point cloud information M1 and the point cloud information M2 on which the point cloud alignment processing has been performed.

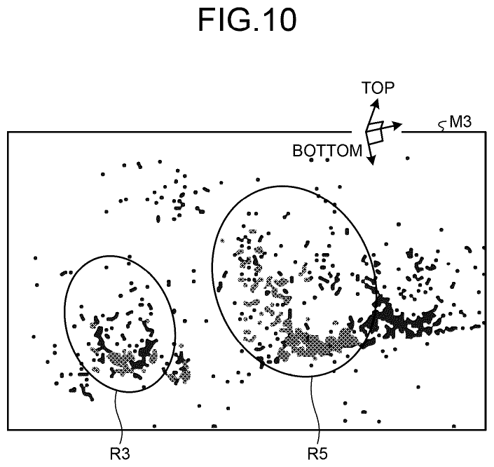

FIG. 10 is a diagram illustrating an example of integrated point cloud information M3 generated by integration processing in the reverse parking of the moving body 2 illustrated in FIG. 5. As illustrated in FIG. 10, the integrated point cloud information M3 includes both the point cloud information M1 related to the front VSLAM processing and the point cloud information M2 related to the rear VSLAM processing. Accordingly, the information includes a large amount of point cloud information regarding the region R3 corresponding to car1, the region R5 corresponding to car2, and the like.

Note that the above-described integration processing is performed in conjunction with input of vehicle state information indicating a change in the operation state (gear switching in the present embodiment)

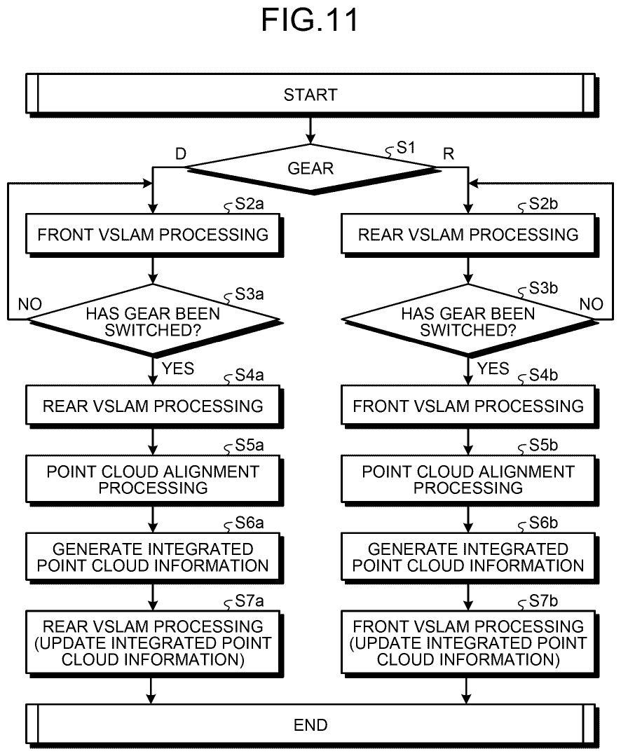

FIG. 11 is a flowchart illustrating an example of a flow of the integration processing illustrated in FIGS. 5 to 10. As illustrated in FIG. 11, the integration processing unit 29 determines whether the gear is put forward (for example, drive “D”) or backward (for example, reverse “R”) (step S1). Hereinafter, an example in which the forward gear is defined as drive “D” and the reverse gear is as reverse “R” will be described.

When having determined that the gear is in the state of drive “D” (D in step S1), the integration processing unit 29 performs the front VSLAM processing described above (step S2a). The integration processing unit 29 repeatedly performs the front VSLAM processing until the gear is switched (No in step S3a).

On the other hand, when the gear is switched from drive “D” to reverse “R” (Yes in step S3a), the integration processing unit 29 performs the above-described rear VSLAM processing (step S4a).

The integration processing unit 29 performs point cloud alignment using the rear point cloud information obtained by the rear VSLAM processing and the front point cloud information obtained by the front VSLAM processing (step S5a).

The integration processing unit 29 generates integrated point cloud information by using the rear point cloud information and the front point cloud information on which the point cloud alignment processing has been performed (step S6a).

The integration processing unit 29 performs the rear VSLAM processing in accordance with the backward movement of the moving body 2, and sequentially updates the integrated point cloud information (step S7a).

On the other hand, when having determined that the gear is in reverse “R” state in step S1 (R in step S1), the integration processing unit 29 performs the rear VSLAM processing described above (step S2b). The integration processing unit 29 repeatedly performs the rear VSLAM processing until the gear is switched (No in step S3b).

On the other hand, when the gear is switched from reverse “R” to drive “D” (Yes in step S3b), the integration processing unit 29 performs the front VSLAM processing described above (step S4b).

Using the front point cloud information obtained by the front VSLAM processing and the rear point cloud information obtained by the rear VSLAM processing, the integration processing unit 29 performs alignment processing of the both point clouds (step S5b).

The integration processing unit 29 generates integrated point cloud information by using the front point cloud information and the rear point cloud information on which the point cloud alignment processing has been performed (step S6b).

The integration processing unit 29 performs the front VSLAM processing in accordance with the forward movement of the moving body 2, and sequentially updates the integrated point cloud information (step S7b).

Returning to FIG. 3, the determination unit 30 receives the environmental map information including the integrated point cloud information from the integration processing unit 29, and calculates the distance between the moving body 2 and the surrounding three-dimensional object using the surrounding position information and the self-position information accumulated in the environmental map information 26A.

Furthermore, the determination unit 30 determines the projection shape of a projection plane using the distance between the moving body 2 and the surrounding three-dimensional object, and generates projection shape information. The determination unit 30 outputs the generated projection shape information to the deformation unit 32.

Here, the projection plane is a three-dimensional surface on which a surrounding image of the moving body 2 is to be projected. The surrounding images of the moving body 2 are captured images of the surroundings of the moving body 2, being captured images captured by each of the image capturing units 12A to 12D. The projection shape of the projection plane is a three-dimensional (3D) shape virtually formed in a virtual space corresponding to the real space. In the present embodiment, the determination of the projection shape of the projection plane performed by the determination unit 30 is referred to as projection shape determination processing.

In addition, the determination unit 30 calculates an asymptotic curve of the surrounding position information with respect to the self-position by using the surrounding position information of the moving body 2 and the self-position information, accumulated in the environmental map information 26A.

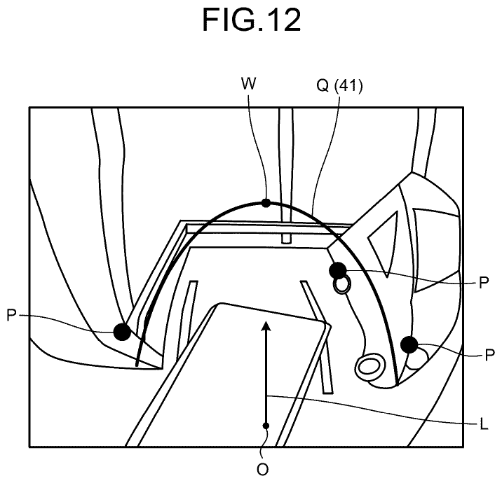

FIG. 12 is a diagram illustrating an asymptotic curve Q generated by the determination unit 30. Here, the asymptotic curve is an asymptotic curve regarding a plurality of detection points P in the environmental map information 26A. FIG. 12 illustrates an example in which the asymptotic curve Q is illustrated in a projection image obtained by projecting a captured image on a projection plane in a top view of the moving body 2. For example, it is assumed that the determination unit 30 has specified three detection points P in order of proximity to the self-position S of the moving body 2. In this case, the determination unit 30 generates the asymptotic curves Q regarding these three detection points P.

The determination unit 30 outputs the self-position and the asymptotic curve information to the virtual viewpoint gaze line determination unit 34.

The deformation unit 32 deforms the projection plane based on the projection shape information determined using the environmental map information including the integrated point cloud information, received from the determination unit 30. The deformation unit 32 is an example of the deformation unit.

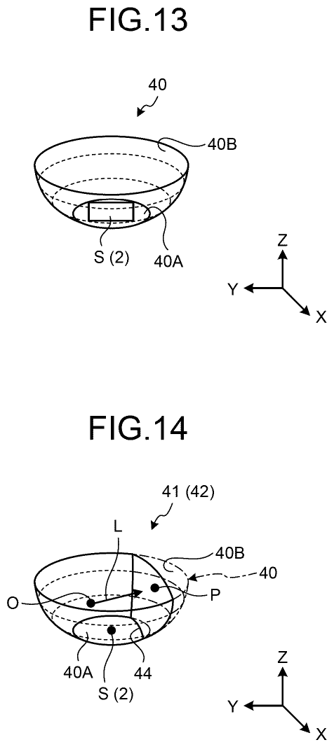

FIG. 13 is a schematic view illustrating an example of a reference projection plane 40. FIG. 14 is a schematic diagram illustrating an example of a projection shape 41 determined by the determination unit 30. That is, the deformation unit 32 deforms the pre-stored reference projection plane illustrated in FIG. 13 based on the projection shape information, and determines a deformed projection plane 42 as the projection shape 41 illustrated in FIG. 14. The deformation unit 32 generates deformed projection plane information based on the projection shape 41. This deformation of the reference projection plane is performed based on the detection point P closest to the moving body 2 as a reference. The deformation unit 32 outputs the deformed projection plane information to the projection transformation unit 36.

Furthermore, for example, the deformation unit 32 deforms the reference projection plane to a shape along an asymptotic curve of a predetermined plural number of the detection points P in order of proximity to the moving body 2 based on the projection shape information.

The virtual viewpoint gaze line determination unit 34 determines virtual viewpoint gaze line information based on the self-position and the asymptotic curve information.

The determination of the virtual viewpoint gaze line information will be described with reference to FIGS. 12 and 14. For example, the virtual viewpoint gaze line determination unit 34 determines, as a gaze line direction, a direction passing through the detection point P closest to the self-position S of the moving body 2 and being perpendicular to the deformed projection plane. Furthermore, for example, the virtual viewpoint gaze line determination unit 34 fixes the orientation of the gaze line direction L, and determines the coordinates of a virtual viewpoint O as a certain Z coordinate and certain XY coordinates in a direction away from the asymptotic curve Q toward the self-position S. In this case, the XY coordinates may be coordinates at a position farther from the asymptotic curve Q than the self-position S. Subsequently, the virtual viewpoint gaze line determination unit 34 outputs virtual viewpoint gaze line information indicating the virtual viewpoint O and the gaze line direction L to the projection transformation unit 36. Note that, as illustrated in FIG. 14, the gaze line direction L may be a direction from the virtual viewpoint O toward the position of a vertex W of the asymptotic curve Q.

Based on the deformed projection plane information and the virtual viewpoint gaze line information, the projection transformation unit 36 generates a projection image obtained by projecting the captured image acquired from the image capturing unit 12 on the deformed projection plane. The projection transformation unit 36 transforms the generated projection image into a virtual viewpoint image and outputs the virtual viewpoint image to the image combining unit 38. Here, the virtual viewpoint image is an image obtained by visually recognizing the projection image in a certain direction from the virtual viewpoint.

The projection image generation processing performed by the projection transformation unit 36 will be described in detail with reference to FIG. 14. The projection transformation unit 36 projects a captured image onto the deformed projection plane 42. The projection transformation unit 36 generates a virtual viewpoint image, which is an image obtained by visually recognizing the captured image projected on the deformed projection plane 42 in the gaze line direction L from a certain virtual viewpoint O (not illustrated). The position of the virtual viewpoint O may be the latest self-position S of the moving body 2, for example. In this case, the values of the XY coordinates of the virtual viewpoint O may be set as the values of the XY coordinates of the latest self-position S of the moving body 2. In addition, the value of the Z coordinate (position in the vertical direction) of the virtual viewpoint O may be set as the value of the Z coordinate of the detection point P closest to the self-position S of the moving body 2. The gaze line direction L may be determined based on a predetermined reference, for example.

The gaze line direction L may be set as a direction from the virtual viewpoint O toward the detection point P closest to the self-position S of the moving body 2, for example. The gaze line direction L may be a direction passing through the detection point P and being perpendicular to the deformed projection plane 42. The virtual viewpoint gaze line information indicating the virtual viewpoint O and the gaze line direction L is created by the virtual viewpoint gaze line determination unit 34.

For example, the virtual viewpoint gaze line determination unit 34 may determine, as the gaze line direction L, a direction passing through the detection point P closest to the self-position S of the moving body 2 and being perpendicular to the deformed projection plane 42. Furthermore, the virtual viewpoint gaze line determination unit 34 may fix the orientation of the gaze line direction L, and may determine the coordinates of a virtual viewpoint O as a certain Z coordinate and certain XY coordinates in a direction away from the asymptotic curve Q toward the self-position S. In this case, the XY coordinates may be coordinates at a position farther from the asymptotic curve Q than the self-position S. Subsequently, the virtual viewpoint gaze line determination unit 34 outputs virtual viewpoint gaze line information indicating the virtual viewpoint O and the gaze line direction L to the projection transformation unit 36. Note that, as illustrated in FIG. 14, the gaze line direction L may be a direction from the virtual viewpoint O toward the position of a vertex W of the asymptotic curve Q.

The projection transformation unit 36 receives virtual viewpoint gaze line information from the virtual viewpoint gaze line determination unit 34. The projection transformation unit 36 receives the virtual viewpoint gaze line information, thereby specifying the virtual viewpoint O and the gaze line direction L. The projection transformation unit 36 then generates a virtual viewpoint image, which is an image obtained by visually recognizing the captured image projected on the deformed projection plane 42 in the gaze line direction L from the virtual viewpoint O. The projection transformation unit 36 outputs the virtual viewpoint image to the image combining unit 38.

The image combining unit 38 generates a combined image obtained by extracting a part or all of the virtual viewpoint image. For example, the image combining unit 38 performs stitching processing or the like of a plurality of virtual viewpoint images (here, four virtual viewpoint images corresponding to the image capturing units 12A to 12D) in a boundary region between the image capturing units.

The image combining unit 38 outputs the generated combined image to the display unit 16. Note that the combined image may be a bird's-eye view image having the upper side of the moving body 2 as the virtual viewpoint O, or may be an image in which the moving body 2 is displayed as a translucent image with the virtual viewpoint O set in the moving body 2.

Note that the projection transformation unit 36 and the image combining unit 38 constitute an image generation unit 37. The image generation unit 37 is an example of the image generation unit.

### Configuration Examples of Integration Processing Unit 29 and Determination Unit 30

Next, an example of a detailed configuration of the integration processing unit 29 and the determination unit 30 will be described.

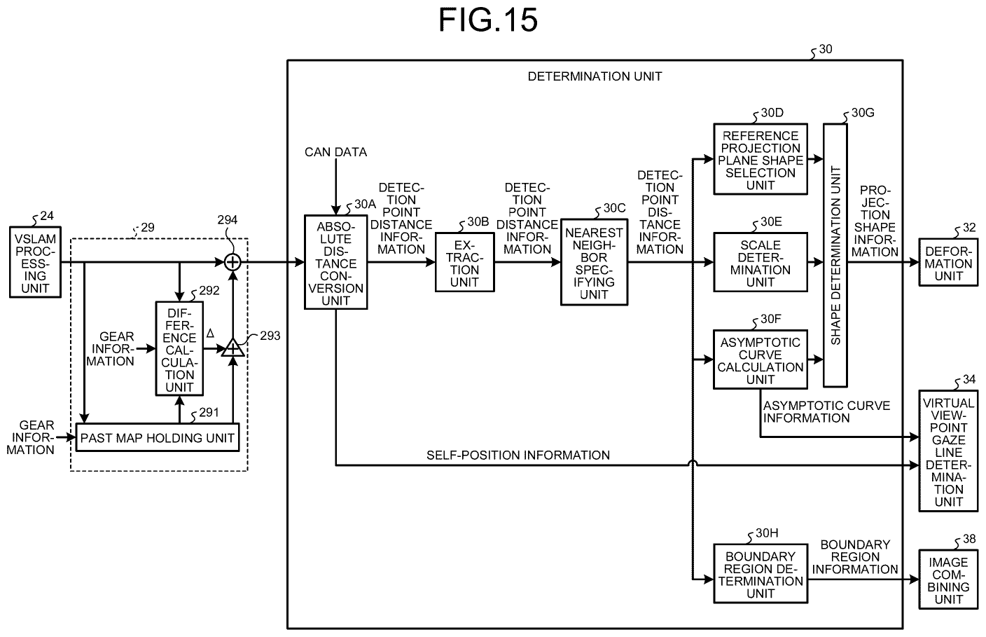

FIG. 15 is a schematic diagram illustrating an example of a functional configuration of the integration processing unit 29 and the determination unit 30. As illustrated in FIG. 15, the integration processing unit 29 includes a past map holding unit 291, a difference calculation unit 292, an offset processing unit 293, and an integration unit 294. In addition, the determination unit 30 includes an absolute distance conversion unit 30A, an extraction unit 30B, a nearest neighbor specifying unit 30C, a reference projection plane shape selection unit 30D, a scale determination unit 30E, an asymptotic curve calculation unit 30F, a shape determination unit 30G, and a boundary region determination unit 30H.

The past map holding unit 291 loads and stores (holds) the environmental map information output from the VSLAM processing unit 24 in accordance with a change in the vehicle state information of the moving body 2. For example, the past map holding unit 291 holds point cloud information included in the latest environmental map information output from the VSLAM processing unit 24 using, as a trigger, an input of gear information (vehicle state information) indicating the gear switching (at a gear switching timing).

The difference calculation unit 292 performs point cloud alignment processing between the point cloud information included in the environmental map information output from the VSLAM processing unit 24 and the point cloud information held by the past map holding unit 291. For example, the difference calculation unit 292 calculates an offset amount, specifically calculates the translational movement amount of one origin with respect to the other origin when the sum of the inter-point distances between the point cloud information included in the environmental map information output from the VSLAM processing unit 24 and the point cloud information held by the past map holding unit 291 is the smallest, as an offset amount A.

The offset processing unit 293 offsets the point cloud information (coordinates) held by the past map holding unit 291 by using the offset amount calculated by the difference calculation unit 292. For example, the offset processing unit 293 adds the offset amount A to the point cloud information held by the past map holding unit 291 and translates the point cloud information.

The integration unit 294 generates integrated point cloud information by using the point cloud information included in the environmental map information output from the VSLAM processing unit 24 and using the point cloud information output from the offset processing unit 293. For example, the integration unit 294 generates the integrated point cloud information by superimposing the point cloud information output from the offset processing unit 293 on the point cloud information included in the environmental map information output from the VSLAM processing unit 24. The integration unit 294 is an example of an integration unit.

The absolute distance conversion unit 30A converts the relative positional relationship between the self-position and the surrounding three-dimensional object, which can be known from the environmental map information 26A, into an absolute value of the distance from the self-position to the surrounding three-dimensional object.

Specifically, speed data of the moving body 2 included in CAN data received from the ECU 3 of the moving body 2 is used, for example. For example, in the case of the environmental map information 26A illustrated in FIG. 4, the relative positional relationship between the self-position S and the plurality of detection points P can be obtained, but the absolute value of the distance is not calculated. Here, the distance between the self-position S3 and the self-position S2 can be obtained from the inter-frame period in which the self-position calculation is performed and the speed data between the inter-frame period based on the CAN data. The relative positional relationship of the environmental map information 26A is similar to that of the real space. Therefore, the absolute value of the distance from the self-position S to all the other detection points P can also be obtained by the obtained distance between the self-position S3 and the self-position S2. When the detection unit 14 acquires the distance information of the detection point P, the absolute distance conversion unit 30A may be omitted.

Then, the absolute distance conversion unit 30A outputs the calculated measurement distance of each of the plurality of detection points P to the extraction unit 30B. Furthermore, the absolute distance conversion unit 30A outputs the calculated current position of the moving body 2 to the virtual viewpoint gaze line determination unit 34 as self-position information of the moving body 2.

The extraction unit 30B extracts a detection point P present within a specific range among the plurality of detection points P the measurement distance about which has been from the absolute distance conversion unit 30A. An example of the specific range is a range from a road surface on which the moving body 2 is located to a height corresponding to the vehicle height of the moving body 2. The range is not limited to this range.

By the extraction unit 30B extracting the detection point P within the range, it is possible to extract the detection point P such as an object that hinders the traveling of the moving body 2 or an object located adjacent to the moving body 2, for example.

Subsequently, the extraction unit 30B outputs the measurement distance of each of the extracted detection points P to the nearest neighbor specifying unit 30C.

The nearest neighbor specifying unit 30C divides the surroundings of the self-position S of the moving body 2 for each specific range (for example, angular range), and specifies the detection point P closest to the moving body 2 or the plurality of detection points P in order of proximity to the moving body 2 for each range. The nearest neighbor specifying unit 30C specifies the detection point P using the measurement distance received from the extraction unit 30B. The present embodiment will describe an exemplary mode in which the nearest neighbor specifying unit 30C specifies a plurality of detection points P in order of proximity to the moving body 2 for each range.

The nearest neighbor specifying unit 30C outputs the measurement distance of the detection point P specified for each range to the reference projection plane shape selection unit 30D, the scale determination unit 30E, the asymptotic curve calculation unit 30F, and the boundary region determination unit 30H.

The reference projection plane shape selection unit 30D selects a shape of the reference projection plane.

Here, the reference projection plane will be described with reference to FIG. 13. The reference projection plane 40 is, for example, a projection plane having a shape serving as a reference when changing the shape of the projection plane. The shape of the reference projection plane 40 is, for example, a bowl shape, a cylindrical shape, or the like. FIG. 13 illustrates a bowl-shaped reference projection plane 40 as an example.

The bowl shape has a shape including a bottom surface 40A and a side wall surface 40B, having one end of the side wall surface 40B continuous with the bottom surface 40A and the other end thereof being open. The width of the horizontal cross section of the side wall surface 40B increases from the bottom surface 40A side toward the opening side of the other end portion. The bottom surface 40A has a circular shape, for example. Here, the circular shape is a shape including a perfect circular shape and a circular shape other than the perfect circular shape such as an elliptical shape. The horizontal cross section is an orthogonal plane orthogonal to the vertical direction (arrow Z direction). The orthogonal plane is a two-dimensional plane express along an arrow X direction orthogonal to the arrow Z direction and along an arrow Y direction orthogonal to the arrow Z direction and the arrow X direction. Hereinafter, the horizontal cross section and the orthogonal plane may be referred to as an XY plane. Note that the bottom surface 40A may have a shape other than a circular shape, such as an egg shape.

The cylindrical shape is a shape including the circular bottom surface 40A and the side wall surface 40B continuous with the bottom surface 40A. The side wall surface 40B constituting the cylindrical reference projection plane 40 has a cylindrical shape in which an opening at one end is continuous to the bottom surface 40A and the other end is open. However, the side wall surface 40B constituting the cylindrical reference projection plane 40 has a shape in which the diameter of the XY plane is substantially constant from the bottom surface 40A side toward the opening side of the other end portion. Note that the bottom surface 40A may have a shape other than a circular shape, such as an egg shape.

In the present embodiment, a case where the shape of the reference projection plane 40 is a bowl shape illustrated in FIG. 13 will be described as an example. The reference projection plane 40 is a three-dimensional model virtually formed in a virtual space in which the bottom surface 40A is a surface substantially matching the road surface below the moving body 2 and the center of the bottom surface 40A is defined as the self-position S of the moving body 2.

By reading one specific shape from the plurality of types of reference projection planes 40, the reference projection plane shape selection unit 30D selects the shape of the reference projection plane 40. For example, the reference projection plane shape selection unit 30D selects the shape of the reference projection plane 40 according to the positional relationship and a stabilization distance and the like between the self-position and the surrounding three-dimensional object. Note that the shape of the reference projection plane 40 may be selected by a user's operation instruction. The reference projection plane shape selection unit 30D outputs the determined shape information of the reference projection plane 40 to the shape determination unit 30G. As described above, the present embodiment will describe an exemplary mode in which the reference projection plane shape selection unit 30D selects the bowl-shaped reference projection plane 40.

The scale determination unit 30E determines the scale of the reference projection plane 40 having the shape selected by the reference projection plane shape selection unit 30D. For example, the scale determination unit 30E determines such that reduction of scale is to be performed when the detection point P exists in plurality in a range of a predetermined distance from the self-position S. The scale determination unit 30E outputs scale information regarding the determined scale to the shape determination unit 30G.

Using each of the stabilization distances of the detection point P closest to the self-position S for each range from the self-position S, received from the nearest neighbor specifying unit 30C, the asymptotic curve calculation unit 30F outputs asymptotic curve information regarding the calculated asymptotic curve Q to the shape determination unit 30G and the virtual viewpoint gaze line determination unit 34. The asymptotic curve calculation unit 30F may calculate the asymptotic curve Q of the detection point P accumulated for each of the plurality of portions of the reference projection plane 40. The asymptotic curve calculation unit 30F may then output the asymptotic curve information regarding the calculated asymptotic curve Q to the shape determination unit 30G and the virtual viewpoint gaze line determination unit 34.

The shape determination unit 30G enlarges or reduces the reference projection plane 40 having the shape indicated by the shape information received from the reference projection plane shape selection unit 30D to the scale of the scale information received from the scale determination unit 30E. The shape determination unit 30G then determines, as the projection shape, a shape obtained by deforming the enlarged or reduced reference projection plane 40 so as to have a shape along the asymptotic curve information of the asymptotic curve Q received from the asymptotic curve calculation unit 30F.

Here, the determination of the projection shape will be described in detail with reference to FIG. 14. As illustrated in FIG. 14, the shape determination unit 30G determines, as the projection shape 41, a shape obtained by transforming the reference projection plane 40 into a shape passing through the detection point P closest to the self-position S of the moving body 2, which is the center of the bottom surface 40A of the reference projection plane 40. The shape passing through the detection point P means that the side wall surface 40B after deformation has a shape passing through the detection point P. The self-position S is the latest self-position S calculated by the self-position estimation unit 27.

That is, the shape determination unit 30G specifies the detection point P closest to the self-position S among the plurality of detection points P registered in the environmental map information 26A. Specifically, the XY coordinates of the center position (self-position S) of the moving body 2 is set as (X, Y)=(0, 0). Subsequently, the shape determination unit 30G specifies the detection point P having a minimized X²+Y² as the detection point P closest to the self-position S. The shape determination unit 30G then determines, as the projection shape 41, a shape obtained by deforming the side wall surface 40B of the reference projection plane 40 so as to have a shape passing through the detection point P.

More specifically, the shape determination unit 30G determines the deformed shape of the bottom surface 40A and a partial region of the side wall surface 40B as the projection shape 41 so that the partial region of the side wall surface 40B becomes a wall surface passing through the detection point P closest to the moving body 2 when the reference projection plane 40 is deformed. The deformed projection shape 41 will have a shape rising from a rising line 44 on the bottom surface 40A toward the center of the bottom surface 40A at the viewpoint of the XY plane (in plan view), for example. Here, rising means, for example, bending or folding a part of the side wall surface 40B and the bottom surface 40A toward a direction approaching the center of the bottom surface 40A so that an angle formed by the side wall surface 40B and the bottom surface 40A of the reference projection plane 40 becomes a smaller angle. In the raised shape, the rising line 44 may be located between the bottom surface 40A and the side wall surface 40B, and the bottom surface 40A may remain non-deformed.

The shape determination unit 30G makes a determination such that a specific region on the reference projection plane 40 will be deformed so as to protrude to a position passing through the detection point P at a viewpoint (plan view) of the XY plane. The shape and range of the specific region may be determined based on a predetermined standard. Subsequently, the shape determination unit 30G makes a determination such that the reference projection plane 40 will have a deformed shape having the distance from the self-position S continuously increased from the protruding specific region toward the region other than the specific region on the side wall surface 40B.

For example, as illustrated in FIG. 14, it is preferable to determine the projection shape 41 such that the shape of the outer periphery of the cross section along the XY plane will be a curved shape. Although the shape of the outer periphery of the section of the projection shape 41 is a circular shape, it may be a shape other than the circular shape.

Note that the shape determination unit 30G may determine a shape obtained by deforming the reference projection plane 40 so as to have a shape along the asymptotic curve, as the projection shape 41. The shape determination unit 30G generates an asymptotic curve of a predetermined plural number of the detection points P in a direction away from the detection point P closest to the self-position S of the moving body 2. The number of detection points P may be any number as long as it is plural. For example, the number of detection points P is preferably three or more. In this case, the shape determination unit 30G preferably generates an asymptotic curve of the plurality of detection points P at positions separated by a predetermined angle or more as viewed from the self-position S. For example, the shape determination unit 30G can determine, as the projection shape 41, a shape obtained by deforming the reference projection plane 40 so as to have a shape along the generated asymptotic curve Q in the asymptotic curve Q illustrated in FIG. 12.

Note that the shape determination unit 30G may divide the surroundings of the self-position S of the moving body 2 for each specific range, and may specify the detection point P closest to the moving body 2 or the plurality of detection points P in order of proximity to the moving body 2 for each range. The shape determination unit 30G may then determine, as the projection shape 41, a shape obtained by deforming the reference projection plane 40 so as to have a shape passing through the detection points P specified for each range or a shape along the asymptotic curve Q of the plurality of specified detection points P.

Subsequently, the shape determination unit 30G outputs the projection shape information of the determined projection shape 41 to the deformation unit 32.

Next, an example of a flow of information processing including the point cloud integration processing performed by the information processing device 10 according to the present embodiment will be described.

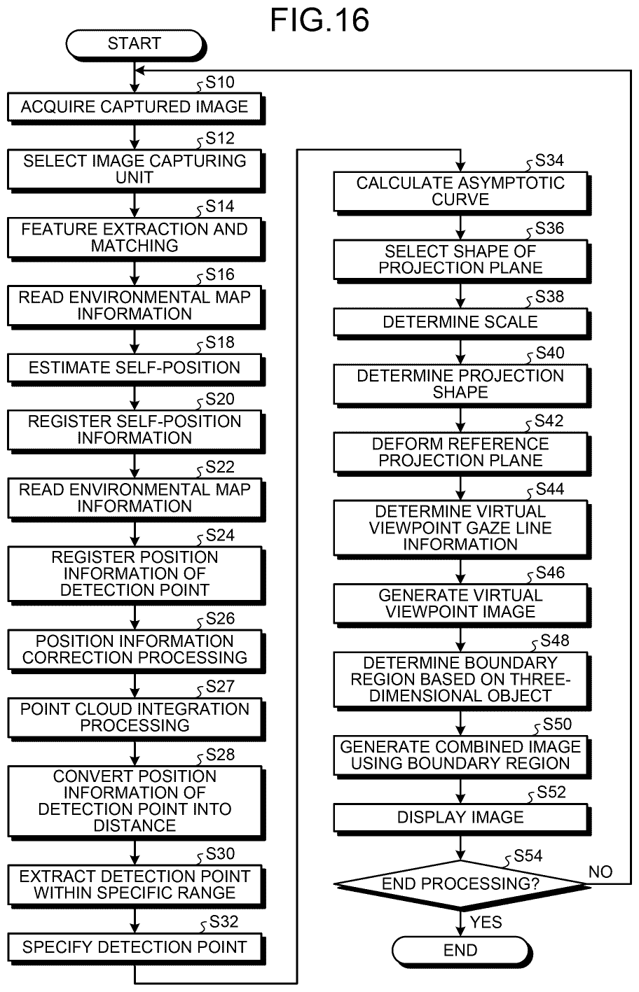

FIG. 16 is a flowchart illustrating an example of a flow of information processing performed by the information processing device 10.

The acquisition unit 20 acquires a captured image from the image capturing unit 12 (step S10). In addition, the acquisition unit 20 directly performs loading of designation information (for example, information indicating that the gear of the moving body 2 is switched to reverse) and loading of a vehicle state.

The selection unit 23 selects at least one of the image capturing units 12A to 12D (step S12).

The matching unit 25 performs feature extraction and matching processing by using a plurality of captured images having different capture timings selected in step S12 and captured by the image capturing unit 12 among the captured images acquired in step S10 (step S14). In addition, the matching unit 25 registers, in the storage unit 26, information of corresponding points between a plurality of captured images having different imaging timings, which have been specified by the matching processing.

The self-position estimation unit 27 reads the matching points and the environmental map information 26A (the surrounding position information and the self-position information) from the storage unit 26 (step S16). The self-position estimation unit 27 estimates a relative self-position with respect to the captured image by projective transformation or the like using the plurality of matching points acquired from the matching unit 25 (step S18), and registers the calculated self-position information in the environmental map information 26A (step S20).

The three-dimensional restoration unit 26B reads the environmental map information 26A (the surrounding position information and the self-position information) (step S22). The three-dimensional restoration unit 26B performs the perspective projection transformation processing using the movement amount (the translation amount and the rotation amount) of the self-position estimated by the self-position estimation unit 27, determines the three-dimensional coordinates (relative coordinates with respect to the self-position) of the matching point, and registers the determined three-dimensional coordinates in the environmental map information 26A, as surrounding position information (step S24).

The correction unit 28 reads the environmental map information 26A (surrounding position information and self-position information). The correction unit 28 corrects the surrounding position information and the self-position information registered in the environmental map information 26A using a technique such as the least squares method, for example, so as to minimize the sum of the differences in distance in the three-dimensional space between the three-dimensional coordinates calculated in the past and the newly calculated three-dimensional coordinates regarding a point successfully matching a plurality of times between a plurality of frames (step S26), and updates the environmental map information 26A.

The integration processing unit 29 receives the environmental map information 26A output from the VSLAM processing unit 24, and performs point cloud integration processing (step S27).

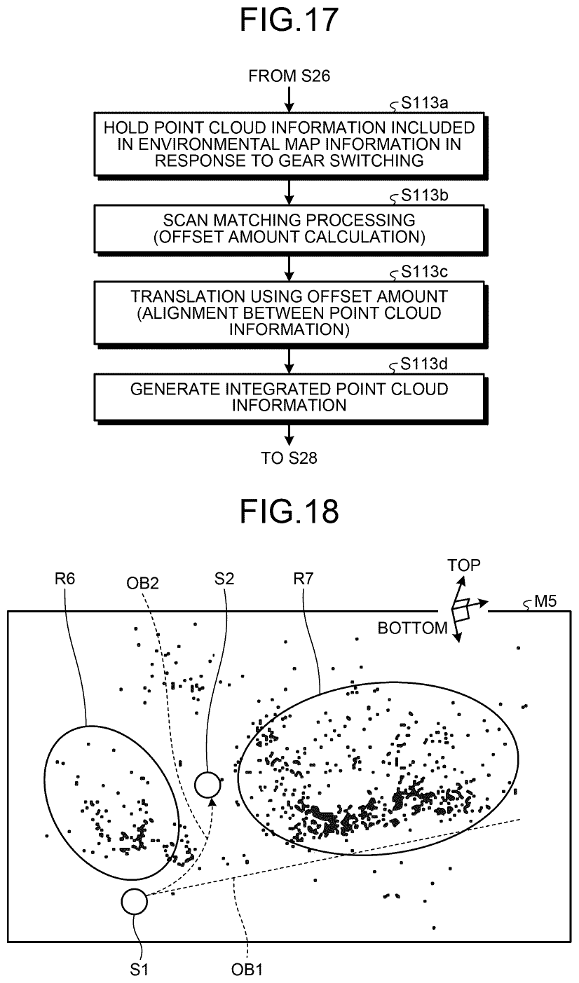

FIG. 17 is a flowchart illustrating an example of a flow of point cloud integration processing in step S27 of FIG. 16. That is, in response to the gear switching, the past map holding unit 291 holds the point cloud information included in the latest environmental map information output from the VSLAM processing unit 24 (step S113a).

The difference calculation unit 292 performs scan matching processing using the point cloud information included in the environmental map information output from the VSLAM processing unit 24 and using the point cloud information held by the past map holding unit 291, and calculates an offset amount (step S113b).

The offset processing unit 293 adds an offset amount to the point cloud information held by the past map holding unit 291 and translates the point cloud information to perform alignment between the point cloud information (step S113c).

The integration unit 294 generates integrated point cloud information by using the point cloud information included in the environmental map information output from the VSLAM processing unit 24 and using the point cloud information output from the offset processing unit 293 (step S113d).

Returning to FIG. 16, the absolute distance conversion unit 30A loads speed data (own vehicle speed) of the moving body 2 included in the CAN data received from the ECU 3 of the moving body 2. Using the speed data of the moving body 2, the absolute distance conversion unit 30A converts the surrounding position information included in the environmental map information 26A into distance information from the current position, which is the latest self-position S of the moving body 2, to each of the plurality of detection points P (step S28). The absolute distance conversion unit 30A outputs the calculated distance information on each of the plurality of detection points P to the extraction unit 30B. Furthermore, the absolute distance conversion unit 30A outputs the calculated current position of the moving body 2 to the virtual viewpoint gaze line determination unit 34 as self-position information of the moving body 2.

The extraction unit 30B extracts the detection point P existing within a specific range among the plurality of detection points P the distance information on which has been received (step S30).

The nearest neighbor specifying unit 30C divides the surroundings of the self-position S of the moving body 2 for each specific range, specifies the detection point P closest to the moving body 2 or a plurality of detection points P in order of proximity to the moving body 2 for each range, and extracts the distance to a nearest neighbor object (step S32). The nearest neighbor specifying unit 30C outputs a measurement distance d of the detection point P specified for each range (the measurement distance between the moving body 2 and the nearest neighbor object) to the reference projection plane shape selection unit 30D, the scale determination unit 30E, the asymptotic curve calculation unit 30F, and the boundary region determination unit 30H.

The asymptotic curve calculation unit 30F calculates an asymptotic curve (step S34), and outputs the result to the shape determination unit 30G and the virtual viewpoint gaze line determination unit 34 as asymptotic curve information.

The reference projection plane shape selection unit 30D selects the shape of the reference projection plane 40 (step S36), and outputs shape information of the selected reference projection plane 40 to the shape determination unit 30G.

The scale determination unit 30E determines a scale of the reference projection plane 40 having the shape selected by the reference projection plane shape selection unit 30D (step S38), and outputs scale information regarding the determined scale to the shape determination unit 30G.

Based on the scale information and the asymptotic curve information, the shape determination unit 30G determines the projection shape as to how to deform the shape of the reference projection plane (step S40). The shape determination unit 30G outputs projection shape information of the determined projection shape 41 to the deformation unit 32.

The deformation unit 32 deforms the shape of the reference projection plane based on the projection shape information (step S42). The deformation unit 32 outputs the deformed projection plane information about the deformation to the projection transformation unit 36.

The virtual viewpoint gaze line determination unit 34 determines virtual viewpoint gaze line information based on the self-position and the asymptotic curve information (step S44). The virtual viewpoint gaze line determination unit 34 outputs virtual viewpoint gaze line information indicating the virtual viewpoint O and the gaze line direction L to the projection transformation unit 36.

Based on the deformed projection plane information and the virtual viewpoint gaze line information, the projection transformation unit 36 generates a projection image obtained by projecting the captured image acquired from the image capturing unit 12 on the deformed projection plane. The projection transformation unit 36 converts the generated projection image into a virtual viewpoint image (step S46) and outputs the virtual viewpoint image to the image combining unit 38.

The boundary region determination unit 30H determines a boundary region based on the distance to the nearest neighbor object specified for each range. That is, the boundary region determination unit 30H determines the boundary region as an overlapping region of the spatially adjacent surrounding images based on the position of the nearest neighbor object of the moving body 2 (step S48). The boundary region determination unit 30H outputs the determined boundary region to the image combining unit 38.

The image combining unit 38 stitches the spatially adjacent perspective projection images using the boundary region to generate a combined image (step S50). That is, the image combining unit 38 generates a combined image by stitching the perspective projection images in four directions according to the boundary region set to the angle in the nearest neighbor object direction. In the boundary region, spatially adjacent perspective projection images are blended with each other at a predetermined ratio.

The display unit 16 displays the combined image (step S52).

The information processing device 10 judges whether to end the information processing (step S54). For example, the information processing device 10 discerns whether a signal indicating a position movement stop of the moving body 2 has been received from the ECU 3, thereby making the judgment in step S54. For example, the information processing device 10 may make the judgment of step S54 by discerning whether an instruction to end the information processing has been received in the form of an operation instruction by the user, or the like.

When a negative judgment is made in step S54 (step S54: No), the processing from step S10 to step S54 is repeatedly performed.

In contrast, when an affirmative judgment is made in step S54 (step S54: Yes), this routine is ended.

When the processing returns from step S54 to step S10 after the correction processing of step S26 is performed, the subsequent correction processing of step S26 may be omitted in some cases. When the processing returns from step S54 to step S10 without performing the correction processing of step S26, the subsequent correction processing of step S26 may be performed in some cases.

As described above, the information processing device 10 according to the embodiment includes the VSLAM processing unit 24 as an acquisition unit, the difference calculation unit 292 and the offset processing unit 293 as alignment processing units, and the integration unit 294 as an integration unit. For example, the VSLAM processing unit 24 acquires the point cloud information related to the front VSLAM processing based on the image data obtained from the image capturing unit 12A provided in front of the moving body 2, and acquires the point cloud information related to the rear VSLAM processing based on the image data obtained from the image capturing unit 12D provided in rear of the moving body 2. The difference calculation unit 292 and the offset processing unit 293 perform alignment processing between the point cloud information related to the front VSLAM processing and the point cloud information related to the rear VSLAM processing. The integration unit 294 generates integrated point cloud information by using the point cloud information related to the front VSLAM processing and the point cloud information related to the rear VSLAM processing, on which the alignment processing has been performed.

Therefore, it is possible to generate the integrated point cloud information in which the point cloud information acquired using the images captured by the different image capturing units in the past and the point cloud information acquired using the image captured by the current image capturing unit are integrated, enabling generation of an image of the surroundings of the moving body using the generated integrated point cloud information. Therefore, for example, even in a case where the vehicle is parked with the turn-around operation, it is possible to solve the shortage of the position information of the surrounding objects obtained by the VSLAM processing.

FIG. 18 is a diagram illustrating point cloud information M5 related to the rear VSLAM processing of the information processing device according to a comparative example. That is, FIG. 18 illustrates the point cloud information M5 acquired only by the rear VSLAM in a case where the moving body 2 is parked with reverse parking in the parking lot PA by switching the gear of the moving body 2 and moving backward along the track OB2 after moving forward temporarily along the track OB1. When the point cloud integration processing according to the present embodiment is not used, an image of the surroundings of the moving body is generated and displayed using the point cloud information M5 acquired only by the rear VSLAM.

Therefore, as illustrated in FIG. 18, in the point cloud information M5 acquired only by the rear VSLAM, car1 illustrated in FIG. 5 immediately deviates from the image capturing range D4 with the backward movement of the moving body 2. Therefore, point cloud information of a region R6 corresponding to car1 becomes sparse, leading to the possibility of occurrence of unstable detection of surrounding objects of the moving body such as car1.

In contrast, the information processing device 10 according to the present embodiment generates the integrated point cloud information illustrated in FIG. 10 by integration processing. As can be seen by comparing the region R3 corresponding to car1 in the integrated point cloud information M3 of FIG. 10 with the region R6 corresponding to car1 in the point cloud information M5 of FIG. 18, for example, the point cloud corresponding to car1 existing in the integrated point cloud information M3 is more than the case of the integrated point cloud information M5. Therefore, the information processing device 10 according to the present embodiment can achieve stable detection of surrounding objects of the moving body such as the car1 as compared with the information processing device according to the comparative example.

The VSLAM processing unit 24 shifts from the front VSLAM processing of acquiring the front point cloud information to the rear VSLAM processing of acquiring the rear point cloud information based on the vehicle state information indicating the state of the moving body 2. After shifting from the front VSLAM processing to the rear VSLAM processing, the difference calculation unit 292 and the offset processing unit 293 perform the alignment processing using the front point cloud information and the rear point cloud information.

Therefore, it is not necessary to simultaneously perform the front VSLAM processing and the rear VSLAM processing, making it possible to reduce the calculation load.

### First Modification

The above embodiment is an exemplary case in which the point cloud integration processing is performed using, as a trigger, an input of the gear information (vehicle state information) indicating that the moving body 2 has switched the gear from drive “D” to reverse “R”. The vehicle state information used as the trigger is not limited to the gear information. For example, the point cloud integration processing can be performed using, as a trigger, information indicating that the steering wheel (steering wheel) has been rotated by a certain amount or more in order to change the traveling direction of the moving body 2, information indicating that the speed has been lowered to a certain speed in preparation for parking of the moving body 2, or the like.

### Second Modification

The above embodiment is an exemplary case of the point cloud integration processing when the moving body 2 performs reverse parking. Alternatively, the point cloud integration processing can also be performed when the moving body 2 performs parallel parking or forward parking. For example, when the moving body 2 performs parallel parking, the point cloud integration processing can be performed using point cloud information related to the side VSLAM processing using images captured by the image capturing units 12B and 12C arranged on the side surface of the moving body 2 and using the point cloud information related to the rear VSLAM processing.

The above embodiment is an exemplary case of point cloud integration processing using the point cloud information related to the front VSLAM processing and the point cloud information related to the rear VSLAM processing. Alternatively, the point cloud integration processing may be performed using the point cloud information related to VSLAM processing in three or more directions (or three or more different locations) such as the point cloud information related to the front VSLAM processing, the point cloud information related to the rear VSLAM processing, and the point cloud information related to the side VSLAM processing.

Furthermore, in a case where the moving body 2 is a drone, the point cloud integration processing can be performed using: the point cloud information related to the upper VSLAM processing that uses the image acquired by the image capturing unit provided on the upper surface of the moving body 2; the point cloud information related to the lower VSLAM processing that uses the image acquired by the image capturing unit provided on the lower surface of the moving body 2; and the point cloud information related to the side VSLAM processing.

### Third Modification

The above embodiment is an exemplary case of point cloud integration processing of switching from the front VSLAM processing to the rear VSLAM processing (or vice versa) using, as a trigger, an input of the vehicle state information and then integrating the point cloud information related to the front VSLAM processing and the point cloud information related to the rear VSLAM processing. Alternatively, the point cloud integration processing can be performed using each piece of point cloud information obtained by performing a plurality of VSLAM processing procedures in parallel.

An example case is providing a front VSLAM processing unit 24 and a rear VSLAM processing unit 24. The front image capturing unit 12A and the rear image capturing unit 12D performs imaging of different directions with respect to the moving body 2, and the VSLAM processing units 24 individually acquire the front point cloud information and the rear point cloud information in parallel. In the difference calculation unit 292 and the offset processing unit 293, as the alignment processing units, perform the alignment processing using the front point cloud information and the rear point cloud information acquired in parallel.

According to such a configuration, the multi-directional VSLAM processing procedures complement each other. This leads to a solution of the shortage of detection information, making it possible to generate a surrounding map with high reliability.

Although the embodiments and the modifications have been described above, the information processing device, the information processing method, and the information processing program disclosed in the present application are not limited to the above-described embodiments and the like. The components can be modified and embodied in each implementation stage and the like without departing from the scope and spirit of the disclosure. In addition, various inventions can be formed by an appropriate combination of a plurality of constituent elements disclosed in the above embodiments and modifications. For example, some components may be deleted from all the components described in the embodiments.

Note that the information processing device 10 of the above embodiment and modifications is applicable to various devices. For example, the information processing device 10 of the above-described embodiment and each modification is applicable to various systems such as a monitoring camera system that processes an image obtained from a monitoring camera and an in-vehicle system that processes an image of a surrounding environment outside a vehicle.

According to one aspect of the information processing device disclosed in the present application, it is possible to solve the issue of the shortage of the position information of the surrounding objects obtained by the VSLAM processing.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing device comprising:
an acquisition unit that acquires first point cloud information based on first image data obtained from a first image capturing unit provided at a first position of a moving body and that acquires second point cloud information based on second image data obtained from a second image capturing unit provided at a second position different from the first position of the moving body;
an alignment processing unit that performs alignment processing on the first point cloud information and the second point cloud information; and
an integration processing unit that generates integrated point cloud information by using the first point cloud information and the second point cloud information on both of which the alignment processing has been performed.

2. The information processing device according to claim 1,
wherein the acquisition unit shifts from first processing of acquiring the first point cloud information to second processing of acquiring the second point cloud information, based on state information indicating a state of the moving body, and
the alignment processing unit performs the alignment processing using the first point cloud information acquired in the first processing and the second point cloud information acquired in the second processing.

3. The information processing device according to claim 2,
wherein the alignment processing unit calculates difference information including at least one of a translational movement amount and a rotational movement amount of at least one of the first point cloud information and the second point cloud information, and performs the alignment processing based on the obtained difference information.

4. The information processing device according to claim 2,
wherein the state information includes at least one of information indicating a change of a traveling direction of the moving body or speed information of the moving body.

5. The information processing device according to claim 1,
wherein the first image capturing unit and the second image capturing unit capture images in mutually different directions with respect to the moving body.

6. The information processing device according to claim 1,
wherein the acquisition unit performs first processing of acquiring the first point cloud information and second processing of acquiring the second point cloud information in parallel, and
the alignment processing unit performs the alignment processing by using the first point cloud information and the second point cloud information acquired in parallel.

7. The information processing device according to claim 1, further comprising:
an image generation unit that projects images of surroundings of the moving body, including the first image data and the second image data onto a projection plane; and
a deformation unit that deforms the projection plane based on the integrated point cloud information.

8. An information processing method to be performed by a computer, the method comprising:
acquiring first point cloud information based on first image data obtained from a first image capturing unit provided at a first position of a moving body and that acquires second point cloud information based on second image data obtained from a second image capturing unit provided at a second position different from the first position of the moving body;
performing alignment processing on the first point cloud information and the second point cloud information; and
generating integrated point cloud information by using the first point cloud information and the second point cloud information on both of which the alignment processing has been performed.

9. A computer program product being information processing program product including programmed instructions embodied in and stored on a non-transitory computer readable medium, wherein the instructions, when performed by a computer, cause the computer to perform:
acquiring first point cloud information based on first image data obtained from a first image capturing unit provided at a first position of a moving body and that acquires second point cloud information based on second image data obtained from a second image capturing unit provided at a second position different from the first position of the moving body;
performing alignment processing on the first point cloud information and the second point cloud information; and
generating integrated point cloud information by using the first point cloud information and the second point cloud information on both of which the alignment processing has been performed.
